(19) United States
(12) Patent Application Publication
(10) Pub. No.: US 2008/0126288 A1
(43) Pub. Date: May 29, 2008

(54) System and a Method for Automatic Management of Quality Assurance Tests

(76) Inventor: Vitaly Krawetzky, Ashdod (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/533,800

(22) Filed: Sep. 21, 2006

(51) Int. Cl. G06N 5/02; G06F 17/30

(52) U.S. Cl. 706/50; 700/109

(57) ABSTRACT

The disclosed system and method automate the decision making abilities of quality assurance (QA) management tools. The proposed invention manages the decision making processes during runtime of the testing tools of any given QA system and provides a solution for automating this process. According to some embodiments the present invention is a decision management platform which controls the activity and the flows of operation of the QA tools. The decision management platform is a decision driven mechanism which analyzes the decision making process performed by the operators of the QA system and automatically provides a decision whenever similar conditions occur. According to preferred embodiments the solution serves both the automatic testing tools and the knowledge management tools. This solution significantly reduces maintenance over testing scenarios and allows a more effective usage of given resources in QA workflow.

### FIELD OF THE INVENTION

The present invention relates in general to systems and methods for managing quality assurance tools and more particularly it relates to systems and methods for automating the decision making processes in integrated systems of quality assurance tools.

### BACKGROUND OF THE INVENTION

The field of quality assurance (QA) includes a wide variety of tools which enable hardware and software developers to perform QA processes. Generally, there are two kinds of solutions on the market that currently serve automatic QA workflow. The first are automatic testing tools which provide strong abilities of test execution and data measuring. These tools require human testers to think about all possible problems and/or events in the tested system that may arise during automated testing. Automated testing tools by leading vendors have undoubted abilities of execution and measuring of a large variety of information, additionally, they support many technologies. However, they do not provide any solutions which may adapt to runtime human decisions; the operator of these systems needs to predict the problems which may occur in order to find them. An additional shortcoming of these systems is that the integration of automated scenarios to adopt ongoing changes within tested systems leads to high complexity and maintenance of existing scenarios. According to studies performed in this field, it is estimated that around 85% of automation testing projects fail, despite the high abilities of the existing testing tools.

The second types of available solutions which serve automatic QA workflow are the knowledge management tools. Knowledge management tools allow effective storage of testing data, automated scenarios and quality assurance documentation. Such systems are used to run existing scenarios, get testing data, follow and manage QA projects, tasks, priorities, bugs and the like.

However, the ability to automate the process of decision making is not a part of the existing solutions. Automated testing tools provide basic abilities to recognize problems based on the prediction made by the operators of the system. Knowledge management tools provide the ability to save, view and manage information and expect the operators of the system to make ongoing decisions. In all of the above mentioned solutions, the decision makers are always the analysts, not the automated systems.

There is therefore a need to automate the decision making abilities, which will serve both the automatic testing tools and the knowledge management tools. This solution would significantly reduce maintenance over testing scenarios and allow a more effective usage of given resources in QA workflow.

### SUMMARY

Disclosed is a method of running an automatic quality assurance workflow of testing procedures through a real-time process. The method comprises the steps of identifying a decision point, analyzing the current decision point in accordance with decision tree, and selecting and recording at least one conclusion of said decision. The decision tree is a structural database representing logical connections between previous decisions. At recognized decision points the actions are taken according to recorded user specifications.

At unrecognized decision points the method triggers the user to select a conclusion for the unrecognized decision point.

The method optionally also includes the step of performing unconditional activities of testing procedures. The unconditional activities include at least one of the following: running stress tests, initiating performance data measurements, executing third party tool functionality or ready third party test scripts, and executing any available workflow. Additionally, the method optionally includes the step of performing unconditional tests for collecting data required for the process of decision making. Some of the activities can be processed before the tests, and at least a part of the tests can be processed before the activities.

The decision tree is composed of all the available decision points of all test scenarios and the relations between them. The conclusion of a decision may optionally include a link to another decision point in the decision tree or activating a specific test. The link may optionally be created between two decision points which have similar data concerning its tests and actions. Alternatively, conclusions regarding a specific decision point may optionally be applied according to a different decision point which shares the same data. The decision points may optionally be retrieved in accordance with a given criteria.

Also disclosed is a system for running an automatic quality assurance workflow of testing procedures through real-time process. The system comprises a monitoring module for identifying decision points, a decision tree structural database representing logical connections between existing decisions, a processing module for analyzing the current decision point in accordance with said decision tree and conclusions database enabling the recording of at least one selected conclusion of the decision. At recognized decision points the actions are taken according to recorded user decisions. For unrecognized decision points the system includes a triggering module which enables the user to select a conclusion for the unrecognized decision point.

The system optionally also includes a module for performing unconditional activities of testing procedures. The unconditional activities optionally include running stress tests, initiating performance data measurements, executing third party tool functionality or ready third party test scripts or executing any available workflow. The system optionally also includes a module for performing unconditional tests for collecting data required for the process of decision making.

The conclusion of a decision optionally includes a link to another decision point in the decision tree or activating a specific test. The process module optionally creates a connection between two decision points having similar data concerning its tests and actions. Additionally, the process module optionally applies conclusions of one decision point to another decision point provided that both decision points have common data. The system optionally also includes a query module for retrieving decision points in accordance with a given criteria.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is an illustration of the three-tier structure of the decision points in accordance with some embodiments of the present invention;

FIG. 2 is an illustration of the decision tree in accordance with some embodiments of the present invention;

FIG. 3 is an illustration of the decision tree when automatic connections between decision points are made by the system in accordance with some embodiments of the present invention.

The drawings together with the description make apparent to those skilled in the art how the invention may be embodied in practice.

No attempt is made to show structural details of the invention in more detail than is necessary for a fundamental understanding of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PREFERRED EMBODIMENTS

The present invention provides a solution for the above mentioned shortcoming of existing quality assurance (QA) management tools. The disclosed system and method manage the decision making processes during runtime of the testing tools of any given QA system and provides a solution for automating this process. According to some embodiments the present invention is a decision management platform which controls the activity and the flows of operation of the QA tools. The decision management platform is a decision driven mechanism which analyzes the decision making process performed by the operators of the QA system and automatically provides a decision whenever similar conditions occur.

An embodiment is an example or implementation of the inventions. The various appearances of “one embodiment.” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof; when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

The terms “bottom”, “below”, “top” and “above” as used herein do not necessarily indicate that a “bottom” component is below a “top” component, or that a component that is “below” is indeed “below” another component or that a component that is “above” is indeed “above” another component. As such, directions, components or both may be flipped, rotated, moved in space, placed in a diagonal orientation or position, placed horizontally or vertically, or similarly modified. Accordingly, it will be appreciated that the terms “bottom”, “below”, “top” and “above” may be used herein for exemplary purposes only, to illustrate the relative positioning or placement of certain components, to indicate a first and a second component or to do both.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

According to some embodiments of the present invention the operation of the decision making platform is comprised of two stages. The first is an interactive learning stage in which the system enables the operators of the QA system to control the work flow of the testing procedures. Through a graphic user interface (GUI) the operators may create protocols for running the tests and control the work flow of the tests in real time. Whenever the system encounters a decision making point it represents the possible options to the operators and waits for their decision. It may also present to the operators decisions which were made by other operators of the system at previous stages concerning the same situations so that they may review them and decide whether to except them or to revise these decisions. All decisions provided by the operators are recorded by the platform for implementation in the automatic stage.

Having completed the interactive learning stage the platform may be run in an automatic mode. The platform controls the operation of the QA systems and directs the tests performed by them. Whenever new conditions occur, presenting a decision making point which was not already addressed by the operators, the platform may be configured to perform one of two action courses. According to the first, which is a semiautomatic mode, the platform stops the operation of the QA systems and waits for the operators of the system to make the decision before continuing with running the QA procedures. The decisions provided by the operators of the system are then recorded and implemented automatically by the platform whenever the same conditions occur.

According to the second mode of operation the platform operates in a fully automatic mode. The platform implements the decisions made by the operators for situations which were previously encountered. Whenever the platform encounters a situation in which new conditions were created and a new decision must be made it analyzes all previous decisions and searches for a similar decision made by the operators which may be applied for the current situation in accordance with the decision tree of the platform. Below is a description of the decision tree as it is implemented in some embodiments of the system. The automatic decisions made by the platform may be reviewed and revised by the operators during runtime or after the testing procedure is completed.

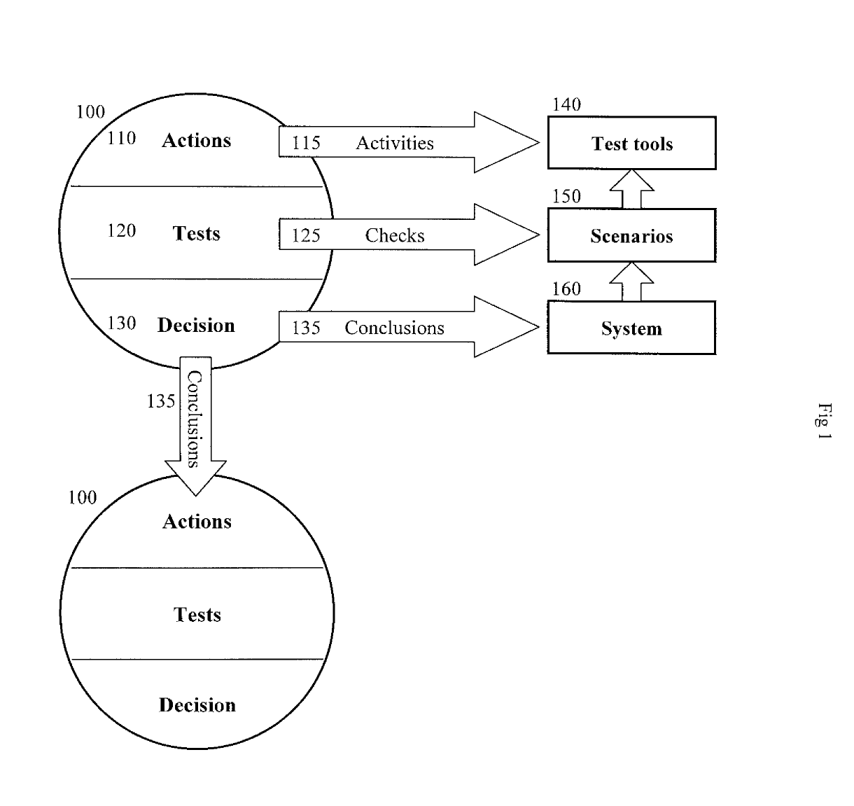

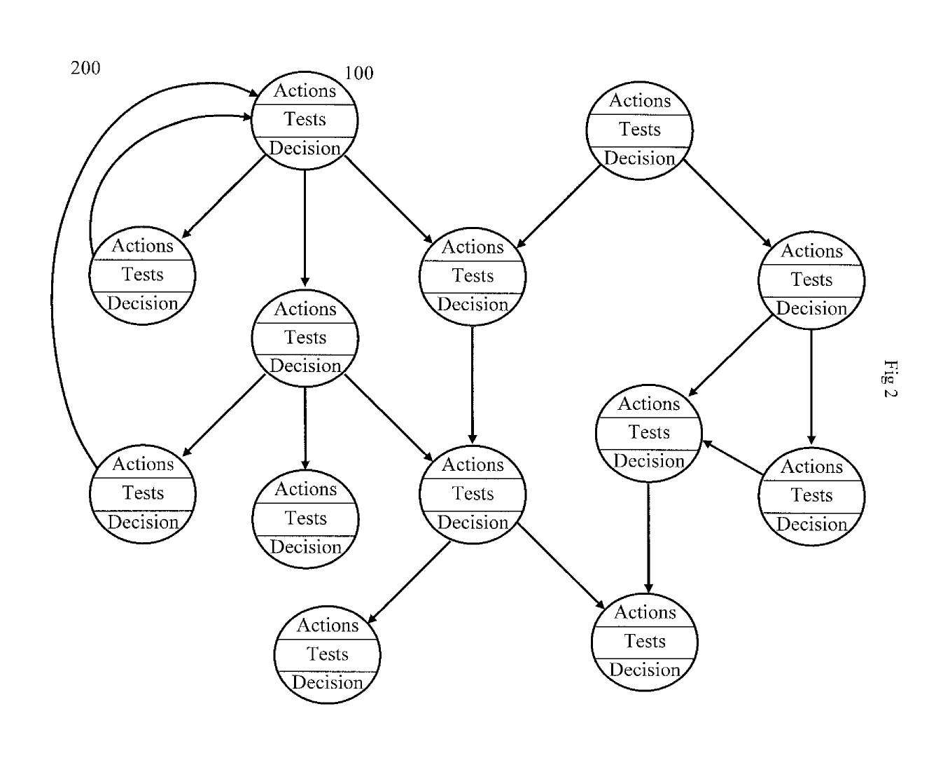

The decision tree is a module which holds the logical connections between all decision points. It is composed of a database and an analyzer. The database is a set of tables where all decision data is stored. The analyzer is a unit responsible for storing, popping, recognizing and processing ongoing decisions, both automated and human-initiated. The decision tree serves both the testing workflow and the QA project management activities. FIG. 1 is an illustration of the three-tier structure of the decision points. Each decision point 100 is comprised of a thee-tier structure of actions 110, tests 120 and decisions 130.

The actions 110 include a set of unconditional activities 115 to be executed. These activities 115 relate to the test tools 140 and may include, for instance, running stress tests, initiating performance data measurements, executing third party tool functionality or ready third party test scripts, or executing any available workflow. The actions 110 may be a long or a short test, involving multiple equipment and systems.

The tests 120 are a set of unconditional checks 125 executed in order to collect data required for the process of decision making. This data may be collected during or after a test scenario 150 and it may use the same tools and equipment as the actions do. The tests 120 may run either before, during, or after the actions activities 115. Both the actions 110 and the tests 120 must be completed logically (by milestone) before proceeding to the decisions 130 stage. For example, the operator may run several actions 110, such as a HTTP stress and initiate performance measurements and then using the tests 120 instruct the system to run a third party software every half an hour over the collected data to discover whether there is a memory leak on server application during these actions. In this case, the actions 110 and tests 120 are logically complete every half an hour despite the fact that activities 115 of the actions 110 may continue running. Since they are logically complete, decisions may be made concerning the accumulated results.

The definitions of the ‘end of session’ are defined in the tests tier 120. In the action tier 110 the length of the session, which determines the duration of the defined activity 115, may be defined. However, the length of session is not a logical entity and is therefore not available for the decisions tier 130. Both the actions tier 110 and the tests tier 120 may receive input from the outside, such as scheduling, variables and test harness files from existing decisions or from overall test scenario 150 definitions. Similarly, the decisions 130 may pass data to consequent points 100 decisions or save data in a common dynamic array, which is available to any other decisions points 100 in the tree in the current testing session.

In the decisions tier 130 the system decides which course of action to take as it is activated by tests tier 120 according to the tests data. The decision 130 may include, for instance, reporting a bug, but often it would lead to proceeding to other decision points 100 in the decision tree. For example, provided that a bug was found (decision 0), the decision may include a command to restart the system under test (decision 1), which may include the command to re-install the tested system (decision 2) and run the same tests again (decision 3). Decision 1 passes the relevant data about the test which was discovered to be problematic to a common array. This information is then available for any other decisions in the same testing scenario.

The dynamic common array (DCA) is created for every test scenario session and holds all dynamic data relevant to the test. Some information is entered by default, but most of the data is defined according to user preferences. The operators define the names and values to be saved in the DCA by any of the decisions in order to be read by the other decisions in the same session.

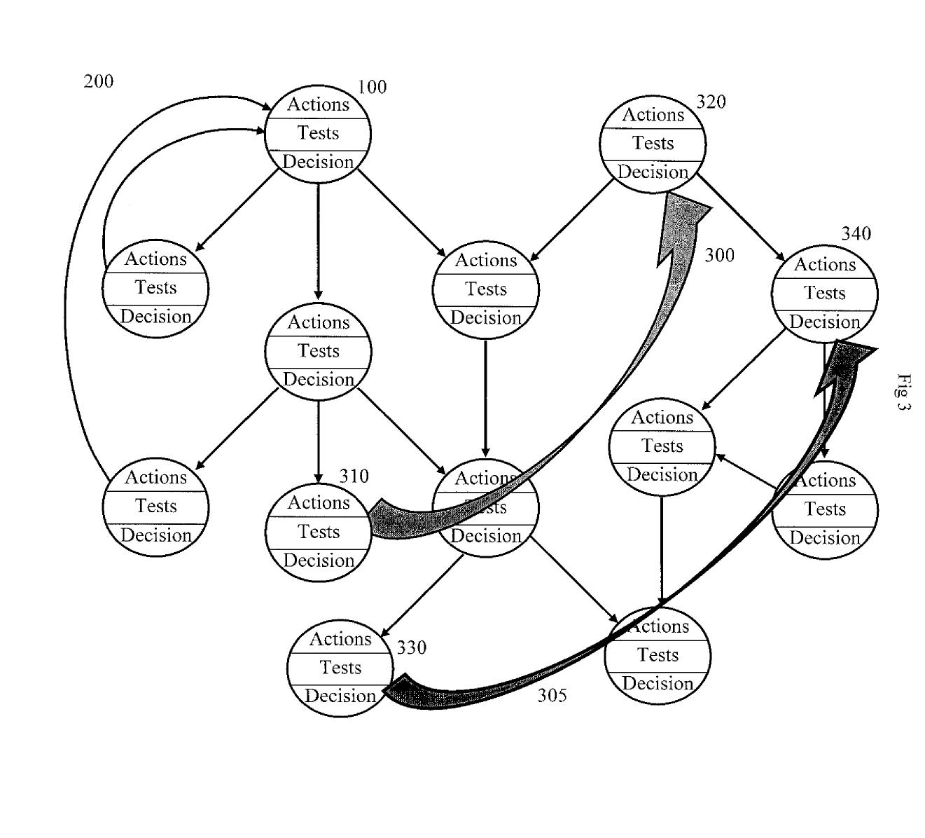

FIG. 2 is an illustration of the decision tree in accordance with some embodiments of the present invention. The decision tree 200 is composed of all the available decision points 100 in the test scenario and the relations between them. All decision points 100 have the same structure as described above. Each decision point 100 may have any number of parents and/or children decision points 100. Different decision points 100 may have the same actions 110 or tests 120 tiers. A new decision point which has the same data both at the tests and at the actions as that of any existing decision point is automatically connected to the original decision point.

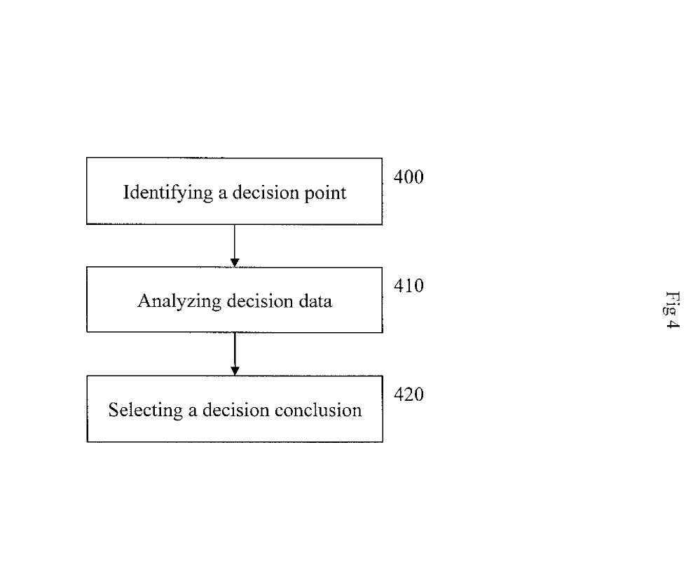

FIG. 3 is an illustration of the decision tree when automatic connections between decision points are made by the system. Similarities which were found between decision point 310 and decision point 320 allow making automatic connection 300. Similarly, similarities which were found between decision point 330 and decision point 340 allow making automatic connection 305. Thus, when decision point 310 is reached, the conclusions of decision 320 are performed, and when decision point 330 is reached the conclusions of decision point 340 are performed. The operators of the system are informed about this new connection. Provided that the operators think that these decision points should not be connected, they are required to add additional information either to the actions or to the tests so that these decision points may be distinguished.

The analysis module of the DCA is responsible for storing new decision points in the database, locating existing decision points by criteria and selecting decision points that answer partial criteria in the interactive mode. Additionally, it also runs and retrieves data from third party tools, application program interfaces (API) and command line interfaces (CLI) which are integrated into the system, stores raw data collected during test sessions, runs regression tests, reproduces bugs and the like according to operators' decisions and performs the system management, such as integrating new tools, APIs, CLIs, user management and DB backups. Appendix A provides an example for the operation of the analysis module in interactive mode.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A method of running an automatic quality assurance workflow of testing procedures through a real-time process, said method comprises the steps of:
identifying a decision point;
analyzing the current decision point in accordance with decision tree, wherein said decision tree is a structural database representing logical connections between previous decisions;
selecting and recording at least one conclusion of said decision.

2. The method of claim 1 wherein at recognized decision points the actions are taken according to recorded user specifications.

3. The method of claim 2 wherein at unrecognized decision points further comprising the step of triggering the user to select a conclusion for said unrecognized decision point.

4. The method of claim 1 further comprising the step of performing unconditional activities of testing procedures.

5. The method of claim 4 wherein unconditional activities include at least one of the following: running stress tests, initiating performance data measurements, executing third party tool functionality or ready third party test scripts, executing any available workflow.

6. The method of claim 1 further comprising the step of performing unconditional tests for collecting data required for the process of decision making.

7. The method of claim 6 wherein at least part of the activities are processed before the tests.

8. The method of claim 6 wherein at least part of the tests are processed before the activities.

9. The method of claim 1 wherein a conclusion of decision includes a link to another decision point in the decision tree.

10. The method of claim 1 wherein a conclusion of a decision includes activating a specific test.

11. The method of claim 1 wherein the decision tree is composed of all the available decision points of all test scenarios and the relations between them.

12. The method of claim 1 further comprising the step of creating a connection point between two decision points having similar data concerning its tests and actions.

13. The method of claim 11 further comprising the step of applying conclusions of one decision point to another decision point wherein both decision points have common data.

14. The method of claim 1 further comprising the step of retrieving decision points in accordance with a given criteria.

15. A system for running an automatic quality assurance workflow of testing procedures through real-time process, said system comprises:
a monitoring module for identifying decision points;
a decision tree structural database representing logical connections between existing decisions;
processing module for analyzing the current decision point in accordance with said decision tree;
conclusions database enabling the recording of at least one selected conclusion of the decision.

16. The system of claim 15 wherein at recognized decision points the actions are taken according to recorded user decisions.

17. The system of claim 15 wherein at unrecognized decision points further comprising a triggering module enabling the user to select a conclusion for the unrecognized decision point.

18. The system of claim 15 further comprising a module for performing unconditional activities of testing procedures.

19. The system of claim 18 wherein unconditional activities include at least one of the following: running stress tests, initiating performance data measurements, executing third party tool functionality or ready third party test scripts, executing any available workflow.

20. The system of claim 15 further comprising the a module for performing unconditional tests for collecting data required for the process of decision making.

21. The system of claim 15 wherein a conclusion of a decision includes a link to another decision point in the decision tree.

22. The system of claim 15 wherein a conclusion of a decision includes activating a specific test.

23. The system of claim 15 wherein the decision tree is composed of all the available decision points of all test scenarios and the relations between them.

24. The system of claim 15 wherein the process module further creates a connection between two decision points having similar data concerning its tests and actions.

25. The system of claim 24 wherein the process module further applies conclusions of one decision point to another decision point wherein both decision points have common data.

26. The system of claim 15 further comprising a query module for retrieving decision points in accordance with a given criteria.
